(19) United States
(12) Patent Application Publication
(10) Pub. No.: US 2021/0162668 A1
(43) Pub. Date: Jun. 3, 2021

(54) POWDER COMPARTMENT WITH SELF-SEALING DESIGN

(71) Applicant: Freemelt AB, Mölndal (SE)

(72) Inventor: Ulf ACKELID, Göteborg (SE)

(73) Assignee: Freemelt AB, Mölndal (SE)

(21) Appl. No.: 17/257,100

(22) PCT Filed: Jul. 3, 2019
(86) PCT No.: PCT/EP2019/067798

§ 371 Date: Dec. 30, 2020

Related U.S. Application Data
(60) Provisional application No. 62/693,454, filed on Jul. 3, 2018.

(51) Int. Cl. B29C 64/255; B22F 12/50; B33Y 30/00; B29C 64/35

(52) U.S. Cl. CPC B29C 64/255; B29C 64/35; B33Y 30/00; B22F 12/50

(57) ABSTRACT

Three-dimensional (3D) printing systems based on powder beds, in which 3D objects are formed by successive consolidation of thin layers of powder are disclosed. The powder compartment from which powder feedstock is distributed in a 3D printer has at least two vertical wall structures movable in relation to each other, the wall structures being at least partly overlapping in the movable direction, providing a variable volume for enclosing powder. Contrary to other available designs, this solution does not need a compressible sealing material, for example an elastomer, a textile felt or a braided rope, to prevent powder leakage from the powder compartment. The benefits are a simple and robust design providing more reliable sealing and no risk of contamination of the powder by debris from sealing material.

### TECHNICAL FIELD

This invention relates to an additive manufacturing machine for producing a three-dimensional object from a granular material, more specifically a powder material, by consolidation of the powder material layer by layer in a powder bed. Consolidation can be carried out by various means, for example fusion or sintering with an energy beam or bonding by binder jetting.

### DESCRIPTION OF RELATED ART

Presently available powder bed additive manufacturing machines normally have a movable table for lowering the consecutively built three-dimensional object inside a build compartment during the manufacturing process. Powder can be fed to the build compartment from a powder compartment and distributed to the build compartment by a powder distributor. The powder compartment can be provided with a movable floor for feeding powder upwards. To prevent leakage of powder, it is common practice to have a compressible sealing material, for example an elastomer, a textile felt or a braided rope, between the movable table and the powder compartment surrounding the powder. In such machines there are often problems with powder leakage due to a defective seal. This could for example be due to challenging environment in the machine such as friction, heat, vacuum, radiation, etc., causing the seal material to degrade and lose its sealing properties. An additional problem is that the powder and three-dimensional object could be contaminated by debris from the degraded seal. Such contamination could degrade the material properties of the three-dimensional object and it could also make it impossible to reuse excess powder from the manufacturing process.

### SUMMARY OF THE INVENTION

This invention relates to an apparatus for manufacturing a three-dimensional object from powder, comprising, a powder compartment having at least two wall structures movable in relation to each other, said wall structures being at least partly overlapping in the movable direction, providing a variable volume for enclosing powder.

In embodiments, said at least two wall structures are vertical wall structures.

In embodiments, said at least two wall structures are inner and outer wall structures.

In embodiments, said outer wall structure has a fixed position and said inner wall structure being movable, wherein a floor is attached to said inner wall structure.

In embodiments, said two wall structures have the shape of an inner cylinder and an outer cylinder.

In embodiments, said two wall structures have the shape of an inner circular cylinder and an outer circular cylinder.

In embodiments, said apparatus comprises a third wall structure for reducing internal unused volume for the three-dimensional object of said powder compartment.

In embodiments, said apparatus comprises a mechanism for emptying loose powder from said powder compartment.

In embodiments, said three-dimensional object is manufactured layer by layer from said powder.

In embodiments, said three-dimensional object is fabricated by additive manufacturing.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF DRAWINGS

In the description of the invention references is made to the following figures, in which:

FIG. 1A shows, in a schematic section view, powder (P) flowing out from an opening in a container, creating a stationary powder slope with an angle of repose α>0.

FIG. 1B shows, in a schematic section view, a liquid (L) flowing out from an opening in a container. In contrast to FIG. 1A, the angle of repose is zero and the liquid will continue to flow until the container is empty.

FIGS. 2A and 2B show, in a schematic section view, a powder compartment with outer and inner wall structures and a movable floor forming a variable volume. FIG. 2A shows the movable floor at a low position. FIG. 2B shows the movable floor at a higher position.

FIGS. 3A and 3B show, in a schematic section view, a powder compartment with outer, middle and inner wall structures and a movable floor forming a variable volume. FIG. 3A shows the movable floor at a low position. FIG. 3B shows the movable floor at a higher position.

FIGS. 4A and 4B show, in a schematic section view, a build compartment (to the left) and a powder compartment (to the right). FIG. 4A represents an early stage of the manufacturing process and FIG. 4B represents a stage where the three-dimensional object has been partially manufactured.

FIGS. 5A and 5B show, in a schematic section view, a powder compartment with telescopic wall structures. FIG. 5A represents an early stage of the manufacturing process with full powder compartment and FIG. 5B represents a later stage where powder has been fed from the powder compartment.

### DESCRIPTION AND DISCLOSURE OF THE INVENTION

To facilitate the understanding of this invention, a few terms are defined below.

The term “powder” refers in this context to any type of granular material, regardless of size, shape and composition of the individual particles or granules that are the constituents of the granular material.

The term “three-dimensional object” refers in this context to any type of three dimensional preform, or any combination of three-dimensional preforms, that can be shaped from powder in an additive manufacturing machine. It is understood that the three-dimensional object, such as it comes out from the additive manufacturing machine, may require further processing to reach a state where it is ready for its intended use.

The term “manufacturing” refer in this context solely to the process of bonding powder particles together into a three-dimensional object in an additive manufacturing machine. The bonding can be carried out for example by fusion or sintering with an energy beam, or by adding a liquid binding agent. Thus, in this context, the term “manufacturing” does not imply that the three-dimensional object has reached its final state. The three-dimensional object may require further processing to reach a state where it is ready for its intended use.

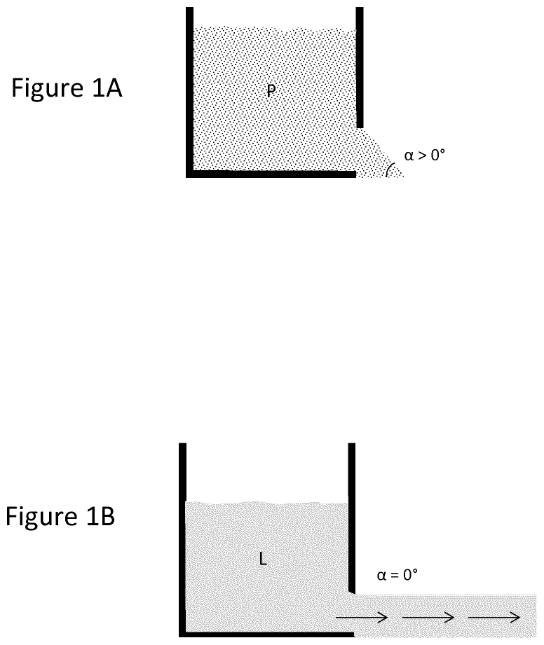

The invention being disclosed here is based on the understanding that powder materials cannot flow upwards and hence a sealing can be achieved by side walls of a container overlapping each other. Powders can support shear stresses unlike gases and liquids. When allowing powder (P) to flow from an opening near the bottom of a container, the powder present an angle of repose α that is greater than zero degrees, as depicted in FIG. 1A. This means that the supporting shear forces internally between the powder grains in the powder (P) will create a powder slope and the powder (P) will stop flowing out from the container when the powder slope has reached the upper edge of the opening. A liquid (L), on the other hand, has normally an angle of repose equal to zero degrees, as depicted in FIG. 1B. The liquid (L) does not create a stationary slope preventing it from flowing out. Thus, the liquid (L) will continue to flow until the container is empty.

The purpose of this invention is to provide a self-sealing powder compartment that does not contaminate the powder, is easy to clean and works for many different powder materials. This purpose is achieved by the apparatus defined in the independent claim. The dependent claims contain advantageous embodiments, further developments and variants of the invention.

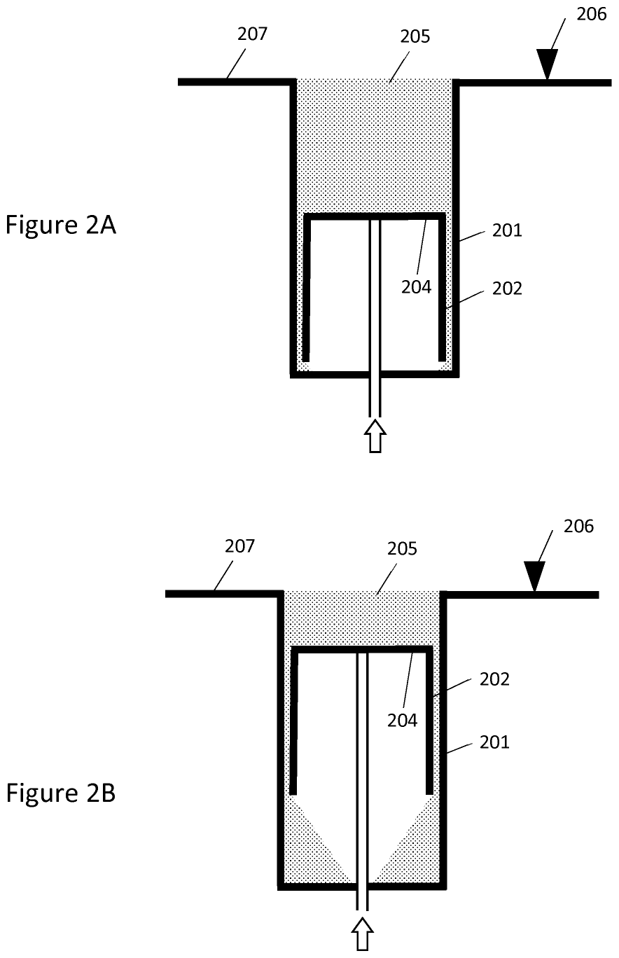

An embodiment of this invention is shown in FIGS. 2A and 2B. An apparatus is provided with a powder compartment for enclosing powder 205, an outer fixed wall structure 201 and an inner wall structure 202 connected to a movable floor 204. Said wall structures can be formed with a suitable cross section in the horizontal plane, for example circular or square or rectangular cross section, for forming the volume of the powder compartment. Said movable floor 204 provides a variable volume of the powder compartment. The volume is decreased by moving the movable floor 204 successively upwards, in this way pushing a portion of powder above the level of the powder table 207. Said portion of powder is then accessible for distribution by the horizontally moving powder distributor 206. The outer 201 and inner 202 wall structures are positioned in parallel with each other, with a small gap between, and are overlapping in the movable direction. Said gap between the inner 202 and the outer wall 201 shall be wide enough to allow free wall movement in presence of powder. The gap can preferably be in the range 0.1-3.0 mm for powder sizes commonly used in powder bed additive manufacturing systems. It should be emphasized that leakage of powder through the gap between the walls is tolerable, since the leaked powder will form stationary slopes preventing a continuous leakage, as illustrated in FIG. 2B. Thus this design can be regarded as “self-sealing” with respect to powder leakage; contrary to existing designs, no foreign sealing material is needed in this case.

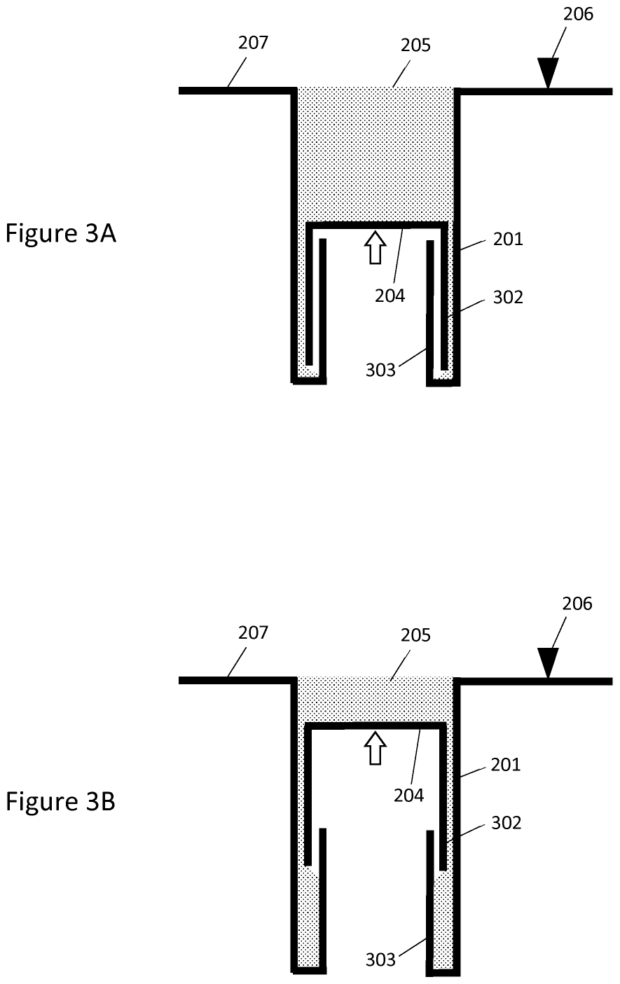

An embodiment of this invention with improved functionality is shown in FIGS. 3A and 3B. An apparatus is provided with a powder compartment for enclosing powder 205, an outer wall structure 201 connected to an innermost wall structure 303, and a middle wall structure 302 connected to a movable floor 204. The wall structures can be formed with a suitable cross section in the horizontal plane, for example circular or square or rectangular cross section, for forming the volume of the powder compartment. Said innermost 303 and outer 201 wall structures are connected powder tight to each other for preventing powder to continuously flow out from the powder compartment. Said movable floor 204 provides a variable volume of the powder compartment. The volume is decreased by moving the movable floor 204 successively upwards, in this way pushing a portion of powder above the level of the powder table 207. Said portion of powder is then accessible for distribution by the horizontally moving powder distributor 206. The outer 201, middle 302 and innermost 303 wall structures are positioned in parallel with each other, with small gaps in between, and the wall structures are at least partly overlapping in the movable direction. The movable part of said powder compartment is constituted of the middle wall structure 302 and the floor 204. Said gaps between the innermost 303, the middle 302 and the outer 201 wall shall be wide enough to allow free wall movement in presence of powder. The gaps can preferably be in the range 0.1-3.0 mm each, for powder sizes commonly used in powder bed additive manufacturing systems. Since the middle wall structure 302 is positioned between the innermost 303 and outer 201 wall structures, powder will be prevented from flowing out from the powder compartment even when the movable part of the powder compartment is moved upwards. Leakage of powder through the gap between the outer 201 and the middle 302 wall is tolerable, since the leaked powder will be trapped in the pocket formed between the outer wall 201 and the innermost wall 303, as illustrated in FIG. 3B. The advantage of this embodiment in relation to the embodiment in FIGS. 2A and 2B is that a smaller powder quantity is needed to accomplish the desired self-sealing effect.

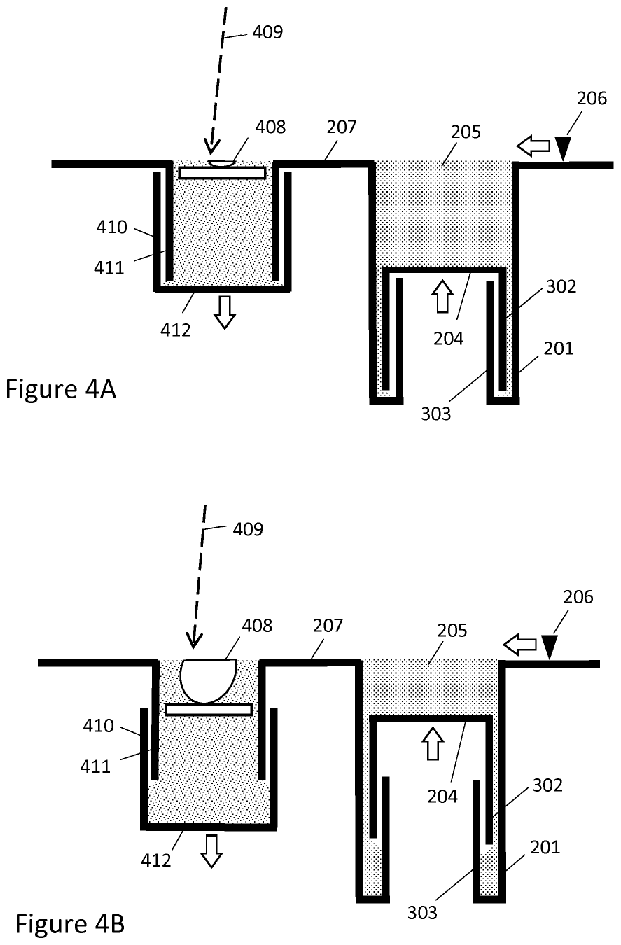

In FIG. 4A is shown an apparatus having a build compartment to the left, containing powder and the manufactured three-dimensional object 408. The floor 412 of the build compartment is successively lowered during the manufacturing process. The powder compartment to the right is provided for feeding powder 205 to the build compartment. The powder compartment has a fixed vertical outer wall structure 201 and a fixed innermost vertical wall structure 303. Between said innermost 303 and outer 201 wall structures, a middle wall structure 302 is provided, with gaps between the middle wall structure 302 and innermost 303 and outer 201 wall structures, respectively. The gap between the movable middle wall structure 302 and fixed outer wall structure 201 will be filled with powder during manufacturing. When the middle wall structure 302 and the floor 204 are moved upwards, the pocket between outer 201 and innermost 303 wall structures will successively be filled with powder, as seen in FIG. 4B. When the middle wall 302 and the floor 204 is moved vertically, the overlap distance between innermost 303 and middle 302 wall structures will decrease. The length of the outer wall structure 201 is designed to be shorter than the sum of the length of the innermost 303 and middle 302 wall structures, in the vertical direction, for the purpose to provide an overlap in the vertical direction between the innermost 303 and middle 302 wall structures for avoiding powder to escape out from the powder compartment. It is desired to always maintain an overlap between the innermost 303 and middle 302 wall structures in the vertical direction to keep a margin against powder leakage out from the powder compartment.

In the build compartment to the left in FIGS. 4A and 4B, a three-dimensional object 408 is manufactured by consolidating successive powder layers, for example with an energy beam 409. Consolidation of powder can also be performed by other means, for example by binder jetting. During manufacturing of the three-dimensional object 408, a movable floor 412 of the build compartment is being lowered layer by layer. The floor 204 in the powder compartment is raised layer by layer during the manufacturing. The three vertical wall structures 201, 302, 303 in the powder compartment are arranged substantially in parallel to each other and overlapping each other in the vertical direction and being spaced with a distance creating two gaps in the horizontal direction. The distance of said gaps could preferably be in the range 0.1-3.0 mm for powder sizes commonly used in powder bed additive manufacturing systems. Even if there is a horizontal gap, the powder will be prevented from flowing out from said powder compartment due to the fact that powder cannot flow upwards. When said movable part is raised successively upwards, the powder 205 will be prevented from flowing out from the compartment due to the overlap between the outer 201 and middle 302 vertical walls creating a vertical distance between the lower edge of said middle wall structure 302 and the upper edge of said innermost wall structure 303. To avoid powder leakage from the powder compartment, the uppermost position of the movable part is limited to a position where the innermost 303 and middle wall structure 302 still allow the powder to form a stagnant, self-sealing slope.

In FIG. 4B is shown a state where the movable floor 412 in the build compartment has been lowered and a portion of the three-dimensional object 408 has been manufactured. To the right in FIG. 4B, the movable floor 204 of the powder compartment has been raised for feeding powder to the build compartment by the powder distributor 206.

For clarity and completeness, FIGS. 4A and 4B also show a schematic powder distributor 206 that moves over the powder bed and a powder table 207 for distribution of a thin layer of powder. It should be pointed out that powder distributors can be embodied in many different ways and the schematic representation in FIGS. 4A and 4B is for illustration only. The powder distributor 206 will not be further discussed, since it is irrelevant for the function of the present invention.

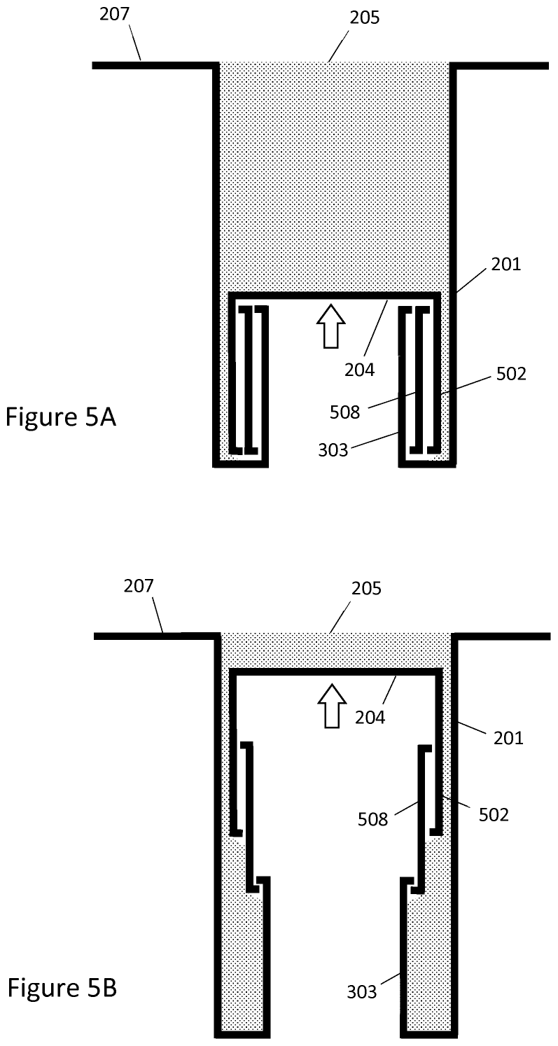

In yet another embodiment, shown in FIGS. 5A and 5B, the powder compartment is telescopic with multiple wall structures sliding into one another. Three wall structures 502, 303, 508 are depicted in FIGS. 5A and 5B, but a larger number of wall structures may also be used. The function of this embodiment is identical with the previous one, with the added advantage that more powder can be stored in the powder compartment with a reduced total height of the powder compartment.

In yet another embodiment, the wall structures can be separable for the purpose of removing and cleaning out powder after a manufacturing process. The outer wall structure can be disassembled from the inner wall structure for access to the space between the walls for cleaning of remaining powder. Alternatively, the inner wall structure can be released from the outer wall structure and lowered by a lowering mechanism. In this way, loose powder can be emptied out from the build compartment, immediately after the manufacturing is finished. This makes it easier to clean out excess powder when the additive manufacturing machine is prepared for the next build.

For some embodiments, the movable part of the powder compartment may at its uppermost position come to a position with negative overlap in the vertical direction between the vertical inner and middle wall structures. Even a small negative overlap can still prevent powder from flowing out, due to the angle of repose of the powder. However, it is desired to keep a positive overlap between the vertical wall structures to have a margin to the position when powder will flow out from the compartment.

These different embodiments should only be considered as examples, not limiting the possible different geometries of the powder compartment. The embodiments can also be employed in various combinations with one another.

1. An apparatus for manufacturing a three-dimensional object from powder, comprising
a powder compartment having at least two wall structures movable in relation to each other, said wall structures being at least partly overlapping in the movable direction, providing a variable volume for enclosing powder.

2. The apparatus according to claim 1, where said at least two wall structures are vertical wall structures.

3. The apparatus according to claim 1, where said at least two wall structures are inner and outer wall structures.

4. The apparatus according to claim 1, where said outer wall structure has a fixed position and said inner wall structure being movable, wherein a floor is attached to said inner wall structure.

5. The apparatus according to claim 1, where said two wall structures have the shape of an inner cylinder and an outer cylinder.

6. The apparatus according to claim 1, where said two wall structures have the shape of an inner circular cylinder and an outer circular cylinder.

7. The apparatus according to claim 1, comprising a third wall structure for reducing internal unused volume for the three-dimensional object of said powder compartment.

8. The apparatus according to claim 1, comprising a mechanism for emptying loose powder from said powder compartment.

9. The apparatus according to claim 1, where said three-dimensional object is manufactured layer by layer from said powder.

10. The apparatus according to claim 1, where said three-dimensional object is fabricated by additive manufacturing.
